(19) United States
(12) Patent Application Publication
(10) Pub. No.: US 2011/0182694 A1
(43) Pub. Date: Jul. 28, 2011

(54) CONNECTOR DEVICE FOR CONSTRUCTION MACHINE

(75) Inventors: Shinji Nishikawa, Ibaraki (JP); Tadatoshi Shimamura, Ibaraki (JP)

(73) Assignee: HITACHI CONSTRUCTION MACHINERY CO., LTD., Tokyo (JP)

(21) Appl. No.: 13/121,823

(22) PCT Filed: Feb. 23, 2010
(86) PCT No.: PCT/JP2010/052690

§ 371 Date: Mar. 30, 2011

(30) Foreign Application Priority Data
Feb. 27, 2009 (JP) 2009-45628

(51) Int. Cl. F16B 33/00; F16B 35/00

(52) U.S. Cl. 411/366.1; 411/337

(57) ABSTRACT

An internally threaded hole (17) of a cap nut (15), with which an external thread (6C) of a mounting bolt (6) is threadedly engaged, is formed as a bottomed threaded hole. Its length dimension is set to a dimension (L1) which makes it possible to secure an axial space (18) with respect to a distal end portion (6C1) of the external thread (6C) when the external thread (6C) of the mounting bolt (6) is tightened until a weakened portion (6D) is fractured. When the mounting bolt (6) is fractured at the weakened portion (6D) by an excessive tightening torque, the fractured external thread (6C) on the distal end side can be left in the internally threaded hole (17) in a threadedly engaged state. In consequence, the external thread (6C) of the mounting bolt (6) remaining in the internally threaded hole (17) can be easily loosened by fingertips and removed.

### TECHNICAL FIELD

The present invention relates to a connector device for a construction machine suitable for connecting a harness in a construction machine such as a hydraulic excavator, a hydraulic crane, or the like.

### BACKGROUND ART

Generally, a hydraulic excavator as a construction machine is largely constituted by an automotive lower traveling structure, an upper revolving structure which is swingably mounted on the lower traveling structure, and a working mechanism liftably mounted on the front side of the upper revolving structure.

Numerous electrical parts such as various switches, sensors, and display units are mounted on a hydraulic excavator, and harnesses for power supply and signal transmission (electrical wirings) extend from these electrical parts. Further, the harnesses extending from the respective electrical parts are extended by using connector devices, and are connected to, for example, a controller for control.

Here, since a connector device used in a hydraulic excavator connects together two connector housings provided at end portions of bundled multiplicities of harnesses, a large force is required at the time of attachment and detachment (connection and separation) because of the frictional resistance between connecting terminals provided in the connector housings. For this reason, as the connector device for a hydraulic excavator, a threaded connector device is generally used in which attachment and detachment are effected by making use of the tightening force (threaded engagement) of threads.

The threaded connector device has two connector housings, and the one side connector housing has a bolt through hole provided penetratingly in a connecting direction of the harnesses and a mounting bolt which is provided by being inserted in the bolt through hole and has a bolt head formed at a proximal end side thereof and an external thread formed at a distal end side thereof in such a manner as to project from an opposite surface opposing the another side connector housing. Meanwhile, the another side connector housing is provided with an internal thread which is provided in an opposite surface opposing the one side connector housing, and to which the external thread of the mounting bolt is threadedly secured.

With the threaded connector device, there are cases where the mounting bolt is tightened excessively, and in such a case the connector housings and the like can possibly be damaged by the force with which the mounting bolt is tightened. Accordingly, among the connector devices, there is one which is so constructed that a weak constricted portion is provided at a bolt head of the mounting bolt for engagement with a thread tightening tool, and the constricted portion is caused to fracture when an excessive tightening force is applied, to thereby prevent damage to the connector housings (Patent Literature 1: Japanese Utility Model Laid-Open No. H6-13070 U).

### SUMMARY OF THE INVENTION

Incidentally, with the connector device according to the above-described Patent Literature 1, if the mounting bolt is tightened with an excessive tightening force, the weak constricted portion provided at the bolt head is fractured before the connector housings are damaged, so that it is possible to prevent damage to the connector housings and the like due to the excessive tightening force. However, in the case where the bolt head is fractured, since its portion is left in a state of being tightened in the connector housing, there is a problem in that the fractured mounting bolt must be removed by using a tool.

In view of the above-discussed problem with the conventional art, it is an object of the present invention to provide a connector device for a construction machine in which the connector housings can be easily attached by the mounting bolt, thereby making it possible to improve the operational efficiency in assembly.

(1) A connector device for a construction machine according to the present invention comprises: two connector housings which are fitted to each other attachably and detachably in face-to-face relation with each other to connect a plurality of harnesses used in a construction machine; a bolt through hole provided in a one side connector housing of the connector housings penetratingly in a connecting direction of the harnesses; a mounting bolt which is provided by being inserted in the bolt through hole of the one side connector housing and has a bolt head formed at a proximal end side thereof and an external thread formed at a distal end side thereof in such a manner as to project from an opposite surface opposing another side connector housing; and an internal thread which is provided in an opposite surface, opposing the one side connector housing, of the another side connector housing, and to which the external thread of the mounting bolt is threadedly secured.

To overcome the above-described problem, the characteristic feature of the construction adopted in the present invention lies in that the mounting bolt is provided with a weakened portion which is located between the bolt head and the external thread and is fractured by a smaller tightening force than a tightening force by which the connector housings are damaged when the mounting bolt is tightened, that the internal thread provided in the another side connector housing is formed as a bottomed internally threaded hole which is open toward the one side connector housing, and that the internally threaded hole is formed with such a length dimension as to be able to secure an axial space with respect to a distal end portion of the external thread of the mounting bolt even if the external thread is tightened until the weakened portion is fractured.

According to this construction, the one side connector housing and the another side connector housing are caused to face each other. In this state, the external thread of the mounting bolt inserted in the bolt through hole of the one side connector housing is threadedly engaged with the internally threaded hole provided in the another side connector housing and is tightened. In consequence, the harnesses can be electrically connected between the connector housings by making use of the tightening force of the mounting bolt with respect to the internally threaded hole.

In the connecting operation of the connector housings using this mounting bolt, there are cases where the mounting bolt is undesirably tightened with an excessive tightening force. In such a case, since the mounting bolt is provided with the weakened portion, the weakened portion of the mounting bolt is fractured by a smaller tightening force than the tightening force which results in the damage of the connector housings. Therefore, it is possible to prevent tightening of the mounting bolt with more than a fixed level, thereby making it possible to protect the connector housings.

Further, even in the case where the mounting bolt is tightened until the weakened portion is fractured, the bottomed internally threaded hole is able to secure an axial space with respect to the distal end portion of the external thread of the mounting bolt. In consequence, the distal end side portion of the fractured mounting bolt is merely in such a state that the external thread is threadedly engaged with the internally threaded hole, and a tightening force is not generated, so that the distal end side portion of the fractured mounting bolt can be loosened simply by hand and removed.

As a result, in the case of replacing the fractured mounting bolt with a new mounting bolt, the fractured mounting bolt can be removed without using a tool, so that the removing operation of the mounting bolt is facilitated, and the operational efficiency in assembly can be improved.

Furthermore, even in the state in which the weakened portion has resulted in a fracture, the internally threaded hole is able to secure a space between its bottom portion and the external thread of the mounting bolt, and therefore does not abut against the external thread of the mounting bolt. As a result, it is possible to prevent a situation in which the operator excessively tightens the mounting bolt without becoming aware of the abutment of the distal end of the external thread against the bottom portion of the internally threaded hole, resulting in the fracture of the mounting bolt, as in the conventional art. Hence, in this respect as well, it is possible to improve the operational efficiency in assembly.

(2) According to the present invention, the construction provided is such that the another side connector housing is provided with a cap nut, and the internally threaded hole is provided in the cap nut.

According to this construction, if focus is placed on the another side connector housing, since the internally threaded hole is provided in the cap nut, it is possible to prevent rainwater and the like from entering between the connector housings through the internally threaded hole. In consequence, it is possible to enhance the waterproofing performance between the connector housings, so that the durability, reliability, and the like can be improved.

(3) According to the present invention, the construction provided is such that a seal member for liquid-tightly sealing the bolt through hole is provided between the one side connector housing and the bolt head of the mounting bolt.

According to this construction, if focus is placed on the one side connector housing, since the bolt through hole is liquid-tightly sealed by the seal member provided between the one side connector housing and the bolt head of the mounting bolt, it is possible to prevent rainwater and the like from entering between the connector housings through the bolt through hole. In consequence, it is possible to enhance the waterproofing performance between the connector housings, so that the durability, reliability, and the like can be improved.

(4) In the present invention, the construction provided is such that another seal member for liquid-tightly sealing between the connector housings when the connector housings are attached to each other in face-to-face relation is provided in at least one of the connector housings.

According to this construction, when the two connector housings are attached together in face-to-face relation, it is possible to prevent rainwater from entering between the connector housings by the another seal member provided on at least one of the connector housings, thereby making it possible to enhance the waterproofing performance.

(5) In the present invention, the construction provided is such that a large diameter hole portion is formed on a side of the opposite surface opposing the another side connector housing in the bolt through hole, the weakened portion of the mounting bolt is a reduced diameter portion which is located in the large diameter hole portion and is formed with a reduced diameter, and a retaining ring for retaining the mounting bolt is fitted at the reduced diameter portion with respect to the bolt head of the mounting bolt.

According to this construction, the mounting bolt can be retained to the one side connector housing by its bolt head and the retaining ring by fitting the retaining ring to the reduced diameter portion by making use of the reduced diameter portion forming the weakened portion of the mounting bolt, thereby making it possible to enhance the operational efficiency at the time of the connecting and separating operation. Moreover, since the reduced diameter portion is formed as the weakened portion, the weakened portion can be provided simply without increasing the number of processing steps.

### BRIEF DESCRIPTION OF THE DRAWINGS

In the accompanying drawings:

FIG. 1 is a cross-sectional view illustrating a connector device for a construction machine in accordance with an embodiment of the present invention in a connected state;

FIG. 2 is a cross-sectional view illustrating the connector device for a construction machine shown in FIG. 1 in a separated state;

FIG. 3 is an enlarged cross-sectional view of an essential portion illustrating in enlarged form a tightened state of an internally threaded hole of a cap nut and an external thread of a mounting bolt in FIG. 1;

FIG. 4 is an enlarged cross-sectional view illustrating in enlarged form a one side connector housing and the mounting bolt;

FIG. 5 is an enlarged cross-sectional view illustrating in enlarged form another side connector housing and the cap nut; and

FIG. 6 is a cross-sectional view illustrating the connector device for a construction machine in accordance with a modification of the present invention.

### MODE FOR CARRYING OUT THE INVENTION

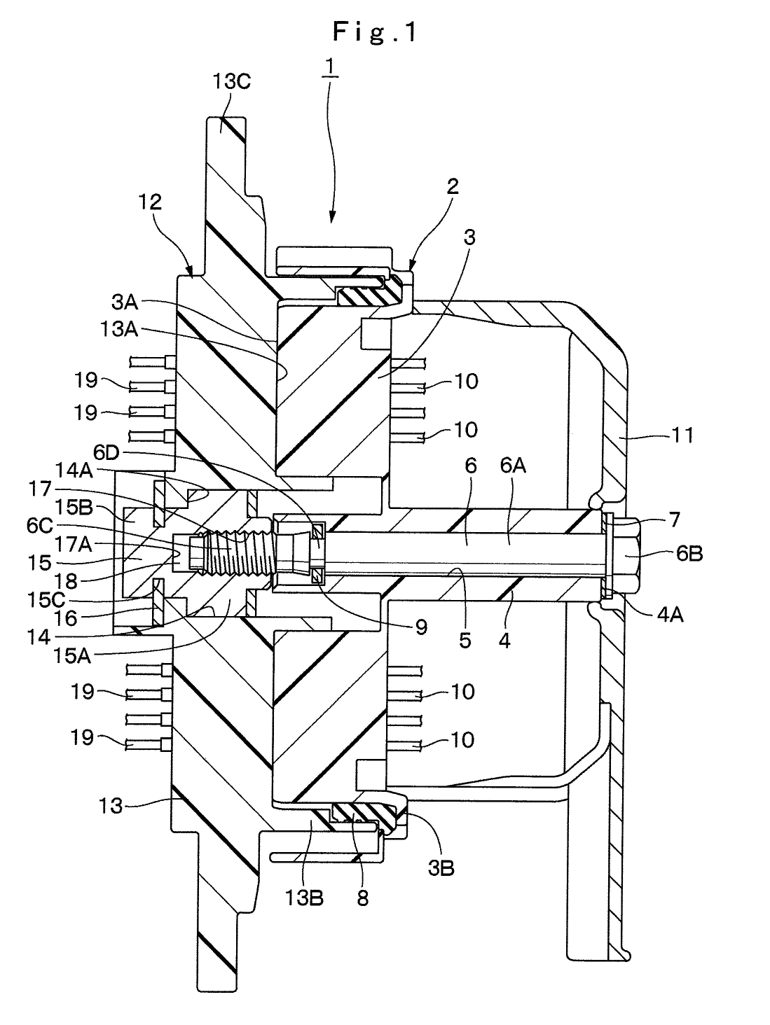

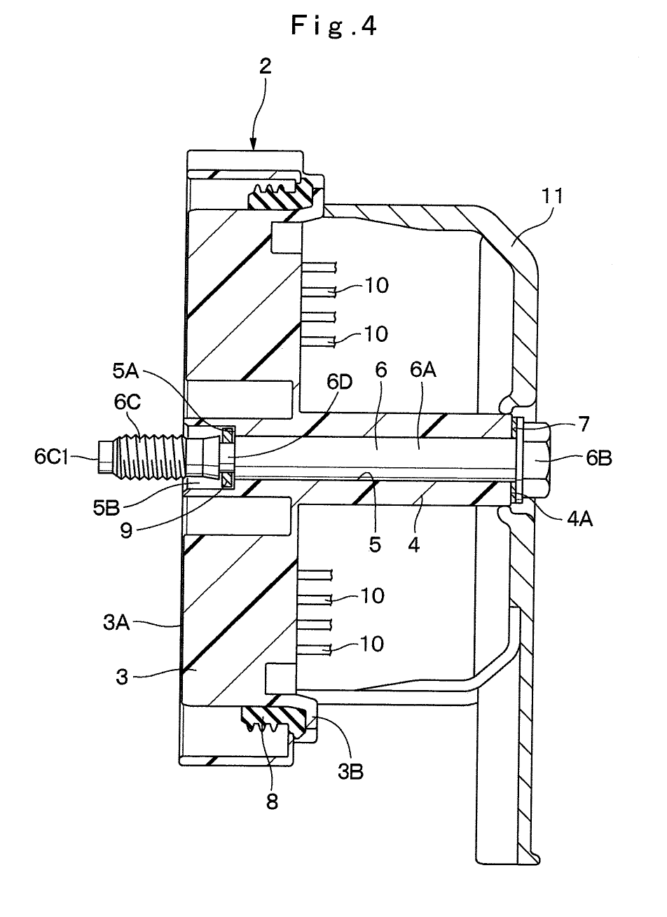

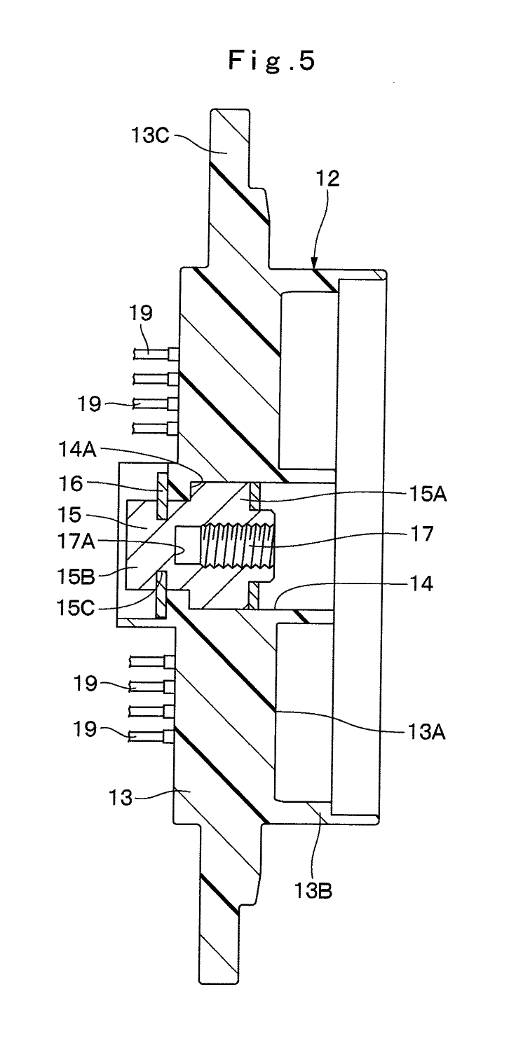

Hereafter, with reference to FIGS. 1 to 5, a detailed description will be given of by citing as an example a case in which a connector device for a construction machine in accordance with an embodiment of the present invention is applied to a hydraulic excavator.

A hydraulic excavator as a typical example of a construction machine to which a connector device 1 in accordance with the present embodiment is applied has mounted thereon electrical parts such as numerous switches, sensors, display units, and the like (none are shown). There are multiplicities of harnesses 10 and 19 for power supply and signal transmission which extend from these electrical parts. For this reason, in the case where the multiplicities of harnesses 10 and 19 are connected, the frictional resistance between connecting terminals 10A and 19A becomes large, so that it is difficult to effect reliable connection and separation by a manual operation. Accordingly, the connector device 1 in accordance with the present embodiment is adapted to effect the connection and separation by making use of the screw tightening force.

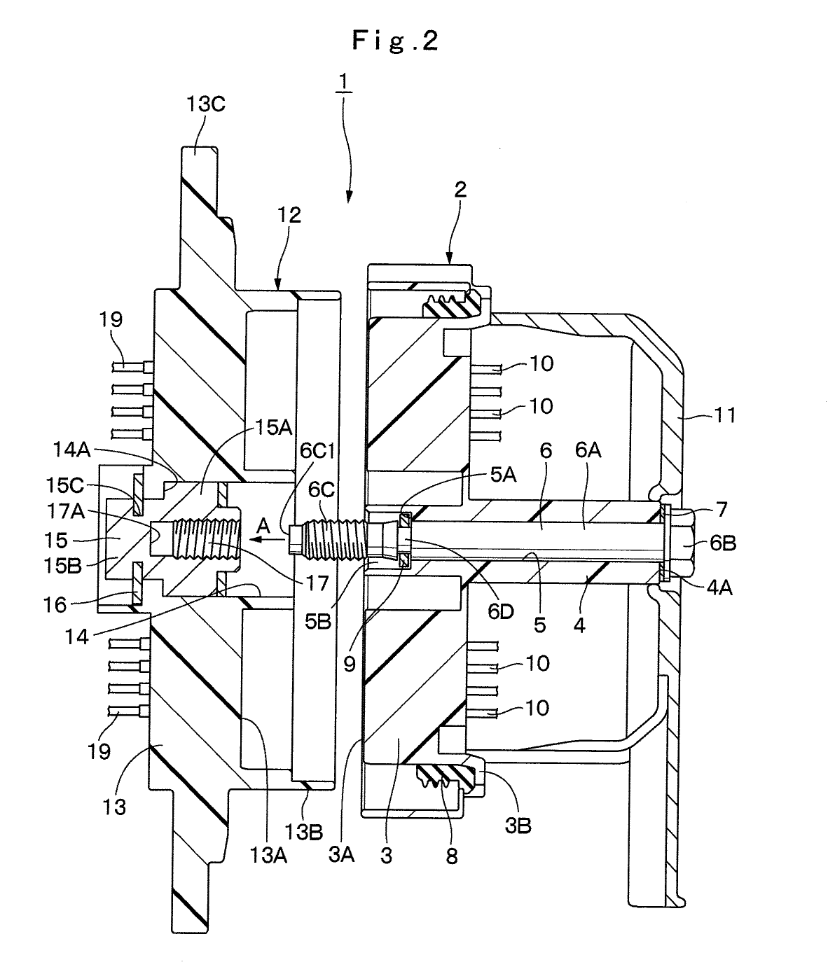

Namely, in FIGS. 1 and 2, designated at 1 is a connector device for a construction machine in accordance with the present embodiment which is provided in a hydraulic excavator, for example. This connector device 1 separably connects the multiplicities of harnesses 10 and 19 which will be described later. The connector device 1 is largely constituted by a one side connector housing 2, a mounting bolt 6, a gasket 7, a packing 8, a retaining ring 9, another side connector housing 12, and a cap nut 15, which will be described hereinafter.

First, a description will be given of the one side connector housing 2, the mounting bolt 6, the packing 8, the retaining ring 9, and the like which constitute the connector device 1.

Namely, denoted at 2 is the one side connector housing which forms an outer configuration of the connector device 1, and this one side connector housing 2 is formed by using, for example, an insulating resin material. The one side connector housing 2 is constituted by a housing body 3 which is formed substantially into the shape of a rectangular parallelepiped and a bolt supporting tube 4 of a small-diameter hollow cylindrical shape which is provided at a substantially central position of that housing body 3 in such a manner as to extend in a connecting direction A (see reference character A in FIG. 2) of the below-described harnesses 10 and 19.

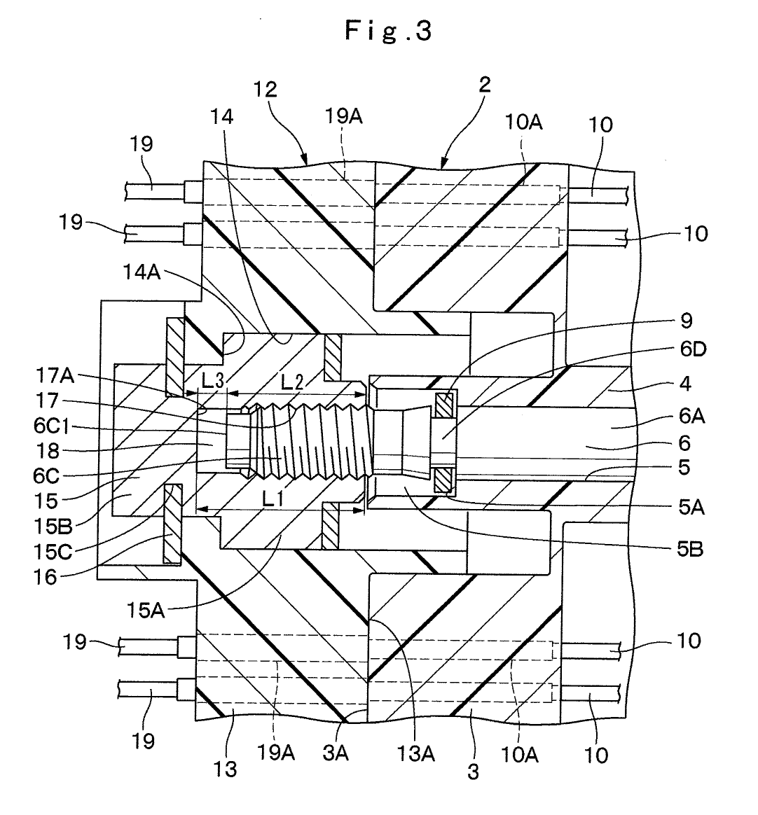

Here, the connecting terminals 10A (only some are illustrated by dotted lines in FIG. 3) constituting end portions of the below-described harnesses 10 are provided in the housing body 3 toward its opposite surface 3A opposing the another side connector housing 12. A flange portion 3B is formed on the outer peripheral side of the housing body 3 at a position opposite to the opposite surface 3A in such a manner as to project in an outwardly oriented manner. The flange portion 3B is for positioning in the connecting direction the below-described packing 8 which is provided on the outer peripheral side of the housing body 3.

The bolt supporting tube 4 is formed as a small diameter hollow cylindrical member whose interior serves as a below-described bolt through hole 5. This bolt supporting tube 4 projects to the opposite side to the opposite surface 3A of the housing body 3, and its projecting end face serves as a sealing surface 4A with which the below-described gasket 7 for providing a seal with respect to a bolt head 6B of the mounting bolt 6 is brought into close contact.

Denoted at 5 is the bolt through hole provided in the bolt supporting tube 4. This bolt through hole 5 is for a shaft portion 6A of the below-described mounting bolt 6 to be rotatably inserted therein, and is provided in a penetrating manner by using as its axial direction the connecting direction A of the harnesses 10 and 19. Further, a large diameter hole portion 5B is formed on the opposite surface 3A side of the housing body 3 in the bolt through hole 5 via a stepped portion 5A. The below-described retaining ring 9 is disposed in this large diameter hole portion 5B in a state in which the retaining ring 9 is fitted on a weakened portion 6D of the mounting bolt 6.

Denoted at 6 is the mounting bolt provided in the one side connector housing 2. This mounting bolt 6 is formed by using, for example, a metallic material, and is rotatably inserted in the bolt through hole 5 in the bolt supporting tube 4 in an axially positioned state. Further, the mounting bolt 6 is largely constituted by the cylindrical shaft portion 6A extending through the bolt through hole 5 in the axial direction, the bolt head 6B of a hexagonal shape provided on a proximal end side of the shaft portion 6A, and an external thread 6C provided on a distal end side of the shaft portion 6A.

Here, the bolt head 6B of the mounting bolt 6 is formed as a flanged bolt head so as to be able to be liquid-tightly brought into close contact with the below-described gasket 7 without damaging it. In addition, the external thread 6C of the mounting bolt 6 is disposed at a position where it projects toward the another side connector housing 12 more than the opposite surface 3A of the housing body 3.

The weakened portion 6D is formed in the mounting bolt 6 by being positioned between the bolt head 6B and the external thread 6C, for example, between the shaft portion 6A and the external thread 6C. This weakened portion 6D is formed as a reduced diameter portion whose diameter is reduced to be smaller than that of the shaft portion 6A by forming a recessed groove over the entire periphery of the shaft portion 6A. Here, as for the weakened portion 6D, its strength (strength conditions including its material, its modulus of longitudinal elasticity, and its cross-sectional area) is set to be weaker to an external force than the shaft portion 6A and the external thread 6C so as to be fractured by a smaller tightening force than a tightening force whereby the connector housings 2 and 12 are damaged when the mounting bolt 6 is tightened.

Namely, if it is assumed that the prescribed tightening torque of the mounting bolt 6 whereby the respective harnesses 10 and 19 can be reliably connected is T1 and that the tightening torque whereby the respective connector housings 2 and 12 are damaged by an excessive tightening of the mounting bolt 6 is T2, a tightening torque T3 by which the weakened portion 6D is fractured is a value greater than the prescribed tightening torque T1 of the mounting bolt 6, and is a value smaller than the tightening torque T2 at which the damage of the respective connector housings 2 and 12 occurs (T1<T3<T2). Accordingly, since the weakened portion 6D can be fractured by a smaller tightening force than the tightening force by which the respective connector housings 2 and 12 are damaged, it is possible to prevent further tightening of the mounting bolt 6, thereby making it possible to protect the connector housings 2 and 12.

Further, the weakened portion 6D is formed as a reduced diameter portion having an entire circumferential groove, and is disposed at the position of the stepped portion 5A of the bolt through hole 5 or inside the large diameter hole portion 5B slightly beyond the stepped portion 5A. As a result, the below-described retaining ring 9 can be fitted on this weakened portion 6D. Accordingly, as the retaining ring 9 is fitted by making use of the weakened portion 6D, the mounting bolt 6 can be retained with respect to the one side connector housing 2 by its bolt head 6B and the retaining ring 9.

Indicated at 7 is the gasket serving as a seal member provided between the sealing surface 4A of the bolt supporting tube 4 and the bolt head 6B of the mounting bolt 6. This gasket 7 is formed in the form of a washer and is brought into close contact with the sealing surface 4A of the bolt supporting tube 4 and the flange surface of the bolt head 6B of the mounting bolt 6 when the mounting bolt 6 is tightened. In consequence, the gasket 7 liquid-tightly seals the interior of the bolt through hole 5 with respect to the outside, thereby making it possible to prevent rainwater and the like from entering between the connector housings 2 and 12 through the bolt through hole 5.

Indicated at 8 is the packing serving as another seal member provided on the outer peripheral side of the housing body 3 constituting the one side connector housing 2. This packing 8 is formed of, for example, an elastic resin material or rubber material, and is attached at a position where it abuts against the flange portion 3B, so as to tighten the periphery of the housing body 3.

Here, as shown in FIG. 1, when the connector housings 2 and 12 are attached together in face-to-face relation, the packing 8 is brought into close contact with an externally fitting cylindrical portion 13B of a housing body 13 on the another side connector housing 12 which is disposed at a position where the externally fitting cylindrical portion 13B surrounds the housing body 3 of the one side connector housing 2. In consequence, the packing 8 liquid-tightly seals between the two connector housings 2 and 12, thereby making it possible to prevent rainwater and the like from entering between the connector housings 2 and 12 through a gap.

Indicated at 9 is the retaining ring provided at the weakened portion 6D of the mounting bolt 6, and this retaining ring 9 is formed as, for example, a C-shaped ring member. In addition, the retaining ring 9 is located within the large diameter hole portion 5B of the bolt through hole 5 and is fitted to the weakened portion 6D of the mounting bolt 6. In consequence, the retaining ring 9 is able to clamp the bolt supporting tube 4 between the same and a bolt head 6B by abutting against the stepped portion 5A, thereby making it possible to prevent the mounting bolt 6 from coming off.

Denoted at 10 are a multiplicity of harnesses which are provided in the housing body 3 of the one side connector housing 2. This multiplicity of harnesses 10 are mounted at predetermined intervals within a predetermined range of the housing body 3 such that the connecting terminals 10A secured to end portions of wires are oriented toward the another side connector housing 12 side. Further, the connecting terminal 10A of each harness 10 is electrically connected to the connecting terminal 19A of each harness 19 provided in the another side connector housing 12 side by being brought into frictional contact therewith. Meanwhile, the connecting terminals 10A and 19A can be separated by moving the connector housings 2 and 12 in the separating direction against the frictional force between the connecting terminals 10A and 19A.

In addition, indicated at 11 is a cover which is provided on the one side connector housing 2. The cover 11 is formed in a dome shape so as to cover from the outer peripheral side of the housing body 3 to the projecting end of the bolt supporting tube 4. The cover 11 protects the harnesses 10 and the like by covering them.

Next, a description will be given of the another side connector housing 12, the cap nut 15, and the like which constitute the connector device 1.

Namely, denoted at 12 is the another side connector housing which is fitted to the one side connector housing 2 attachably and detachably in face-to-face relation therewith. This another side connector housing 12 is formed by using, for example, an insulating resin material and constitutes the outer configuration of the connector device 1 together with the one side connector housing 2. Further, this another side connector housing 12 is largely constituted by the housing body 13 which faces the housing body 3 of the one side connector housing 2 and a nut mounting hole 14 provided in a substantially central position of the housing body 13.

Here, the housing body 13 is formed to be slightly larger than the housing body 3 of the one side connector housing 2. In this housing body 13, the multiplicity of connecting terminals 19A constituting end portions of the below-described harnesses 19 are provided in a direction toward an opposite surface 13A opposing the one side connector housing 2.

Meanwhile, the externally fitting cylindrical portion 13B of a rectangular frame shape, which projects from the opposite surface 13A toward the one side, is formed on the outer peripheral side of the housing body 13. The externally fitting cylindrical portion 13B surrounds the housing body 3 of the one side connector housing 2. Further, the externally fitting cylindrical portion 13B liquid-tightly abuts from the outer peripheral side against the packing 8 provided on the outer peripheral side of the housing body 3. Amounting bracket 13C for mounting the connector device 1 to a structure (not shown) is projectingly provided on the outer peripheral side of the housing body 13 in an outwardly oriented manner.

The aforementioned nut mounting hole 14 is formed at a position where it is coaxial with the mounting bolt 6 and as a stepped hole in which the opposite surface 13A side is of a large diameter. A stepped portion 14A which is formed at a midway position of the nut mounting hole 14 is for restricting the cap nut 15 from moving to the other side. Here, the nut mounting hole 14 is formed as a through hole of, for instance, a polygonal shape or a circular shape provided with a rotation preventing means, so that the cap nut 15 does not corotate when the mounting bolt 6 is tightened.

Denoted at 15 is the cap nut which is provided at a central position of the housing body 13 separately from the housing body 13. Namely, this cap nut 15 is disposed at a position where it opposes the bolt supporting tube 4 (bolt through hole 5) of the housing body 3. The cap nut 15 is formed by using, for example, a metallic material, and is liquid-tightly mounted inside the nut mounting hole 14 of the housing body 13 in a fixed state. Besides, since the cap nut 15 has a below-described bottomed internally threaded hole 17, the cap nut 15 is able to prevent rainwater and the like from entering through this internally threaded hole 17.

As for the cap nut 15, its one side in the connecting direction A (axial direction) is formed as a large diameter portion 15A and its other side is formed as a small diameter portion 15B. The large diameter portion 15A and the small diameter portion 15B are formed as polygonal bodies which are unrotatably fitted inside the nut mounting hole 14, or are formed as circular bodies having a rotation preventing means. Meanwhile, a recessed groove 15C is provided on the outer peripheral side of the small diameter portion 15B at a position where it projects from the nut mounting hole 14 toward the other side. A fixing ring 16 for fixing the cap nut 15 in a locked state with respect to the nut mounting hole 14 is fitted in the recessed groove 15C.

Designated at 17 is the internally threaded hole which is provided in the cap nut 15 and is a characterizing portion of this embodiment. This internally threaded hole 17 is formed as a bottomed threaded hole which is open to the opposite surface 13A side of the housing body 13 constituting the another side connector housing 12. In addition, the external thread 6C of the mounting bolt 6 is threadedly secured in the internally threaded hole 17.

As shown in FIG. 3, as for the internally threaded hole 17, its length dimension (depth dimension) up to a bottom portion 17A is set to a dimension L1. On the other hand, a length dimension at a time when the external thread 6C of the mounting bolt 6 is screwed into the internally threaded hole 17 until the connector housings 2 and 12 are connected is assumed to be L2. Further, a length dimension of a space 18 formed between the bottom portion 17A of the internally threaded hole 17 and a distal end portion 6C1 of the external thread 6C is assumed to be L3. Accordingly, the length dimension L1 of the internally threaded hole 17 is a dimension in which the screwing-in length dimension L2 of the external thread 6C of the mounting bolt 6 and the length dimension L3 of the space 18 are added (L1=L2+L3).

In consequence, even if the mounting bolt 6 is tightened until the weakened portion 6D is fractured, the internally threaded hole 17 formed as a bottomed threaded hole is able to secure the axial space 18 with respect to the distal end portion 6C1 of the external thread 6C of this mounting bolt 6. Accordingly, the external thread 6C which is fractured at the distal end side portion of the mounting bolt 6 is not in a tightened state but is merely threadedly engaged with the internally threaded hole 17, so that the external thread 6C can be easily loosened by a manual operation without using a special tool or the like.

In addition, since the internally threaded hole 17 secures the space 18 so as not to cause the external thread 6C of the mounting bolt 6 to abut against its bottom portion 17A, the weakened portion 6D can be prevented from being fractured unexpectedly irrespective of protecting the connector housings 2 and 12 when the mounting bolt 6 is tightened.

Denoted at 19 are a multiplicity of harnesses which are provided in the housing body 13 of the another side connector housing 12. As shown in FIG. 3, as for the respective harnesses 19 on the another side connector housing 12 side, their connecting terminals 19A are provided in the housing body 13 in a direction toward the one side connector housing 2 so as to be able to be connected in correspondence with the harnesses 10 on the one side connector housing 2. Further, the connecting terminals 10A and 19A of the harnesses 10 and 19 can be electrically connected by, for example, male-female engagement by tightening the external thread 6C of the mounting bolt 6 into the internally threaded hole 17 with a prescribed torque T1. Meanwhile, as the mounting bolt 6 is rotated in a loosening direction, the connecting terminals 10A and 19A can be separated.

The connector device 1 for a construction machine in accordance with this embodiment has the above-described construction, and a description will next be given of the connecting operation of this connector device 1.

First, the one side connector housing 2 and the another side connector housing 12 are made to approach each other in a mutually facing direction (connecting direction A in FIG. 2), and the external thread 6C of the mounting bolt 6 is threadedly engaged with the internally threaded hole 17 of the cap nut 15. Then, as the mounting bolt 6 is tightened with the prescribed torque T1, the one side connector housing 2 and the another side connector housing 12 can be connected, and the harnesses 10 on the one side connector housing 2 and the harnesses 19 on the another side connector housing 12 can be electrically connected concurrently.

In the connecting operation of the connector housings 2 and 12 using this mounting bolt 6, there are cases where the mounting bolt 6 is undesirably tightened with an excessive tightening force. In such a case, since the weakened portion 6D of the mounting bolt 6 is fractured by the smaller tightening torque T3 than the tightening torque T2 by which the connector housings 2 and 12 are damaged, it is possible to prevent further tightening of the mounting bolt 6, thereby making it possible to protect the connector housings 2 and 12.

Besides, in this embodiment, in the case where the mounting bolt 6 is tightened until the weakened portion 6D is fractured, the internally threaded hole 17 is able to secure the axial space 18 between its bottom portion 17A and the distal end portion 6C1 of the external thread 6C of the mounting bolt 6. For this reason, the external thread 6C portion of the fractured mounting bolt 6 can be left in a state of being merely threadedly engaged with the internally threaded hole 17, and the external thread 6C portion which remained in the internally threaded hole 17 can be removed by being easily loosened by the manual operation.

Meanwhile, in the case where the mounting bolt 6 is tightened with the prescribed tightening torque T1, the connector housings 2 and 12 can be moved in a separating direction against the frictional force between the connecting terminals 10A and 19A by rotating the mounting bolt 6 in the loosening direction, thereby making it possible to separate the connecting terminals 10A and 19A.

As described above, according to this embodiment, the internally threaded hole 17 of the cap nut 15, with which the external thread 6C of the mounting bolt 6 is threadedly engaged, is formed as a bottomed threaded hole. Moreover, the length dimension (depth dimension) of the internally threaded hole 17 is set to the dimension L1 which makes it possible to secure the axial space 18 with respect to the distal end portion 6C1 of the external thread 6C when the external thread 6C of the mounting bolt 6 is tightened until the weakened portion 6D is fractured.

Accordingly, in the case where the external thread 6C of the mounting bolt 6 is fractured by an excessive tightening torque, the fractured external thread 6C can be set in the threadedly engaged state in which a tightening force is not generated with respect to the internally threaded hole 17. In consequence, the external thread 6C of the mounting bolt 6 remaining in the internally threaded hole 17 can be easily rotated by fingertips, and can be loosened and removed with ease.

As a result, in the case of replacement of the fractured mounting bolt 6 with a new mounting bolt 6, the fractured mounting bolt 6 can be removed without using a special tool, so that the removing operation of the mounting bolt 6 is facilitated, and the operational efficiency in assembly can be improved.

Further, even in the state in which the weakened portion 6D of the mounting bolt 6 has resulted in a fracture, the internally threaded hole 17 is able to secure the space 18 between its bottom portion 17A and the distal end portion 6C1 of the external thread 6C of the mounting bolt 6. As a result, it is possible to prevent a situation in which the mounting bolt 6 is fractured since the operator has excessively tightened the mounting bolt 6 without becoming aware of the abutment of the distal end portion 6C1 of the external thread 6C against the bottom portion 17A of the internally threaded hole 17 as in the conventional art. In this respect as well, it is possible to improve the operational efficiency in assembly.

In addition, since the another side connector housing 12 is provided with the cap nut 15, and the internally threaded hole 17 is provided in this cap nut 15 as a bottomed threaded hole, it is possible to prevent rainwater and the like from entering between the connector housings 2 and 12 through the internally threaded hole 17. In consequence, it is possible to enhance the waterproofing performance, so that the durability, reliability, and the like of the connector device 1 can be improved.

Meanwhile, since the gasket 7 is provided between the sealing surface 4A of the bolt supporting tube 4 and the bolt head 6B of the mounting bolt 6, it is possible to prevent rainwater and the like from entering between the connector housings 2 and 12 through the bolt through hole 5. In consequence, it is possible to enhance the waterproofing performance, so that the durability, reliability, and the like of the connector device 1 can be improved.

Meanwhile, since the packing 8 is provided on the outer peripheral side of the housing body 3 of the one side connector housing 2, it is possible to prevent rainwater and the like from entering between the connector housings 2 and 12 through the gap with the externally fitting cylindrical portion 13B of the housing body 13 of the another side connector housing 12. This also makes it possible to enhance the waterproofing performance of the connector device 1.

Furthermore, since the weakened portion 6D of the mounting bolt 6 can be utilized as a mounting portion of the retaining ring 9 for retaining the mounting bolt 6, mechanical processing for mounting the retaining ring 9 can be omitted.

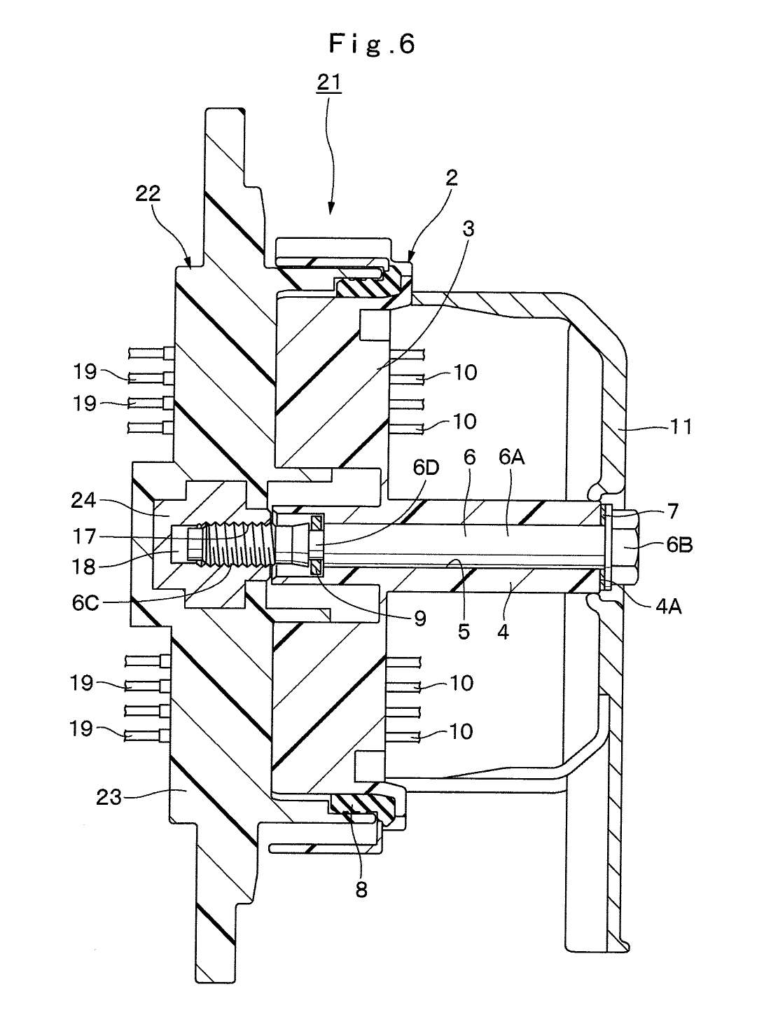

It should be noted that in the embodiment a description has been given by citing as an example the case in which the construction provided is such that the nut mounting hole 14 is provided in the housing body 13 constituting the another side connector housing 12, the cap nut 15 provided separately is inserted and fitted in the nut mounting hole 14, and the cap nut 15 is fixed in the nut mounting hole 14 by the fixing ring 16. However, the present invention is not limited to this particular example. For instance, the construction may be such that, as in a connector device 21 in accordance with a modification shown in FIG. 6, at the time when another side connector housing 22 is resin molded, a cap nut 24 is integrally molded with a housing body 23 in such a manner as to cast a cap nut 24 into a housing body 23.

Further, in the embodiment, the case is exemplified in which the packing 8 serving as another seal member is provided on the outer peripheral side of the housing body 3 constituting the one side connector housing 2. However, the present invention is not limited to this particular example. For instance, the construction may be such that the packing is provided on the inner peripheral side of the externally fitting cylindrical portion 13B of the housing body 13 constituting the another side connector housing 12. Still alternatively, the construction may be such that the packing is provided on both of the outer peripheral side of the housing body 3 of the one side connector housing 2 and the inner peripheral side of the externally fitting cylindrical portion 13B of the housing body 13 of the another side connector housing 12.

Furthermore, in the embodiment a description has been given by citing as an example the case in which the connector device 1 for a construction machine is applied to a hydraulic excavator. However, the present invention is not limited to this particular example, and can be widely applied as a connector device for construction machines such as hydraulic cranes, wheel loaders, and the like.

### DESCRIPTION OF REFERENCE NUMERALS

1, 21: Connector device for a construction machine
2: One side connector housing
3, 13, 23: Housing body
3A, 13A: Opposite surface
4: Bolt supporting tube
4A: Sealing surface
5: Bolt through hole
5B: Large diameter hole portion
6: Mounting bolt
6A: Shaft portion
6B: Bolt head
6C: External thread
6C1: Distal end portion
6D: Weakened portion (Reduced diameter portion)
7: Gasket (Seal member)
8: Packing (Another seal member)
9: Retaining ring
10, 19: Harness
10A, 19A: Connecting terminal
12, 22: Another side connector housing
14: Nut mounting hole
15, 24: Cap nut
17: Internally threaded hole
17A: Bottom portion
18: Space
L1: Length dimension of the internally threaded hole

1. A connector device for a construction machine, comprising: two connector housings which are fitted to each other attachably and detachably in face-to-face relation with each other to connect a plurality of harnesses used in a construction machine; a bolt through hole provided in a one side connector housing of said connector housings penetratingly in a connecting direction of said harnesses; a mounting bolt which is provided by being inserted in said bolt through hole of said one side connector housing and has a bolt head formed at a proximal end side thereof and an external thread formed at a distal end side thereof in such a manner as to project from an opposite surface opposing another side connector housing; and an internal thread which is provided in an opposite surface, opposing said one side connector housing, of said another side connector housing, and to which said external thread of said mounting bolt is threadedly secured, characterized in that:
said mounting bolt is provided with a weakened portion which is located between said bolt head and said external thread and is fractured by a smaller tightening force than a tightening force by which said connector housings are damaged when said mounting bolt is tightened,
said internal thread provided in said another side connector housing is formed as a bottomed internally threaded hole which is open toward said one side connector housing, and
said internally threaded hole is formed with such a length dimension as to be able to secure an axial space with respect to a distal end portion of said external thread of said mounting bolt even if said external thread is tightened until said weakened portion is fractured.

2. A connector device for a construction machine according to claim 1, wherein said another side connector housing is provided with a cap nut, and said internally threaded hole is provided in said cap nut.

3. A connector device for a construction machine according to claim 1, wherein a seal member for liquid-tightly sealing said bolt through hole is provided between said one side connector housing and said bolt head of said mounting bolt.

4. A connector device for a construction machine according to claim 1, wherein another seal member for liquid-tightly sealing between said connector housings when said connector housings are attached to each other in face-to-face relation is provided in at least one of said connector housings.

5. A connector device for a construction machine according to claim 1, wherein a large diameter hole portion is formed on a side of said opposite surface opposing said another side connector housing in said bolt through hole, said weakened portion of said mounting bolt is a reduced diameter portion which is located in said large diameter hole portion and is formed with a reduced diameter, and a retaining ring for retaining said mounting bolt is fitted at said reduced diameter portion with respect to said bolt head of said mounting bolt.
